(19) United States
(12) Patent Application Publication
(10) Pub. No.: US 2003/0023843 A1
(43) Pub. Date: Jan. 30, 2003

(54) Remote processor intelligent reset apparatus and method

(76) Inventors: Chester A. Heath, Boca Raton, FL (US); Kendall A. Honeycutt, Boca Raton, FL (US); Ray Garcia, Boca Raton, FL (US)

Correspondence Address: KAPLAN & GILMAN , L.L.P., 900NROUTE 9 NORTH, WOODBRIDGE, NJ, 07095, US

(21) Appl. No.: 09/915,926

(22) Filed: Jul. 26, 2001

(51) Int. Cl. G06F 15/177

(52) U.S. Cl. 713/2

(57) ABSTRACT

The invention disclosed provides a verification circuit and method for sending an operator-generated signal to a frozen remote computer processor that will be distinguished from an unintentional short circuit. The apparatus includes a USB connective cable having a momentary contact switch able to create a series of intentional short circuits that are transmitted to a counter circuit. According to the method of the invention, the user of the computer having a frozen remote processor activates the switch multiple times within a fixed time period so that the counter and associated circuit recognize that an intentional reset request is being sent, and transmit a signal to reboot the processor.

### RELATED APPLICATION

The invention disclosed herein is based upon the invention in the application entitled “Remote Processor Reset Apparatus And Method,” filed concurrently herewith.

### FIELD OF THE INVENTION

The present invention relates to the field of computer systems, and more particularly to computer systems in which the processor is remote from the monitor.

### BACKGROUND OF THE INVENTION

In pursuit of greater efficiency and better use of space, some organizations have been relocating computer processors (CPUs) to an area remote from the work area of the user. By removing the processor from the workstation, additional space is freed for other purposes. Plural single board computers (SBC) may be used to populate a single rack. Each SBC interfaces to a separate user monitor, keyboard, and mouse, but all SBCs share a common hard disc. According to an exemplary architecture of the present invention, the single drive and plural SBCs operate over a common bus.

Special cabling, such as KVM (Keyboard Video Mouse) extenders or USB repeater cables are utilized to provide appropriate communication speed. Some arrangements have gone to the extent of locating the processors in a secure and locked facility.

Occasionally, all computers encounter problems and become hung, or frozen, preventing the user from performing additional work, frequently losing recent input. Minor computer freezes can often be overcome by deactivating a particular program that is causing the problem, typically by depressing the “control-alternate-delete” keys simultaneously. This method does not work in the case of a full computer freeze, which requires shutting down and rebooting the entire machine. Previously, this shut down would require pressing a “reset” button on the processor that would cut power momentarily and then re-start the computer. Of course, with the processor located remote from the user's workstation, there is no accessible reset button. Re-starting a computer in such a situation might require the user to call a service technician to reset the remote SBC, involving an added delay.

To avoid a service call, some known computer network systems with remotely located mother boards have installed a reset switch at each workstation that is connected to the power supply via a bus. This attempt at correcting the problem has been seen to create another problem by resetting, therefore discontinuing operations of, all the SBCs in the system, since they are all connected to a common bus.

Of course, a computer may be subjected to an occasional short circuit failure. Such a failure could damage components in the processor. It is generally considered best in such a situation not to immediately reactivate the computer, but to first determine the cause of the problem. Activating a currently available reset switch appears to the computer to be similar to a momentary short circuit.

To overcome these drawbacks, the present invention provides a method and apparatus for resetting a selected individual processor from a remote location.

### SUMMARY OF THE INVENTION

A remote processor reset apparatus in the form of a USB or other communications circuit and a method are provided for sending an operator-generated signal to a frozen PROCESSOR that will reset the power thereto. The apparatus involves a USB overcurrent protection circuit including a momentary contact switch connected to create an intentional short circuit and a counter circuit. According to the method of the invention, the user of the computer having a remote processor activates the switch multiple times within a fixed time period for the counter and associated circuit to recognize that an intentional reset request is being sent, to reboot the processor.

In a preferred embodiment, a microprocessor (CPU) receives and transmits commands. In parallel with the microprocessor system is hardware circuitry for detecting a fault, such as a short circuit. When the processor locks up due to an error, the user may simulate a fault, or repetitive faults, which serves as a signal that is detected by the hardware and utilized to reset the system.

### BRIEF DESCRIPTION OF THE DRAWINGS

FIG. 1 is a schematic layout of an exemplary architecture of a rack of SBCs connected to a common disc drive located remotely from individual workstations;

FIG. 2 is an electrical schematic diagram of a first portion of a USB overcurrent circuit according to the invention;

FIG. 3 is an electrical schematic diagram of a second portion of the USB circuit of FIG. 2; and

FIG. 4 is a schematic diagram of a counter circuit that connects to the circuit of FIGS. 2 and 3 to authenticate the signal for resetting the processor.

### DETAILED DESCRIPTION OF THE INVENTION

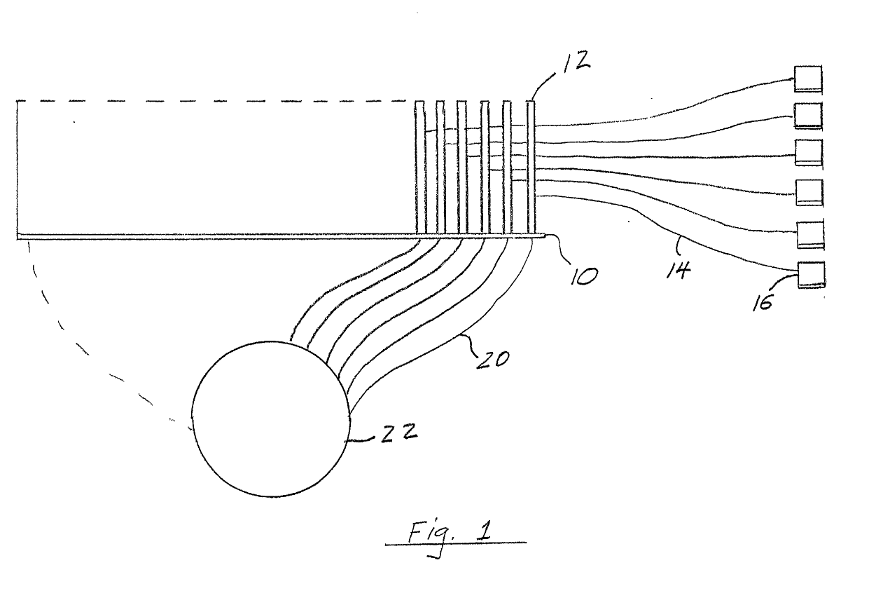

Referring now to the accompanying drawings, FIG. 1 illustrates a schematic layout of the major components of a remote processor computer network system. A rack 10, adapted for securely supporting a plurality of SBCs 12, is mounted at a location that is remote from the workstations 16 of the users of the computer network. Workstations 16 typically each consist of a monitor, a keyboard, and a mouse, not individually numbered. Each SBC 12 is connected to a respective workstation 16 by means of a bus USB connective cable 14. As noted above, to conserve space and cost, individual SBCs 12 do not have individual hard disc drives.

A single hard disc drive 22 is connected to each of SBCs 12 by means of a plurality of connections 20, the number of connections 20 equal to the number of SBCs 12. Connections 20 are made in a manner so that each SBC 12 is able to interact with hard disc drive 22 seamlessly as if the particular SBC 12 and disc drive 22 are a cohesive system. Disc drive 22 is comparatively adapted to receive data from and provide data to a respective SBC 12 individually. The connections 20 are, in actuality, logical connections over a single physical bus, but they may also be accomplished by other means, as are known to those skilled in the art.

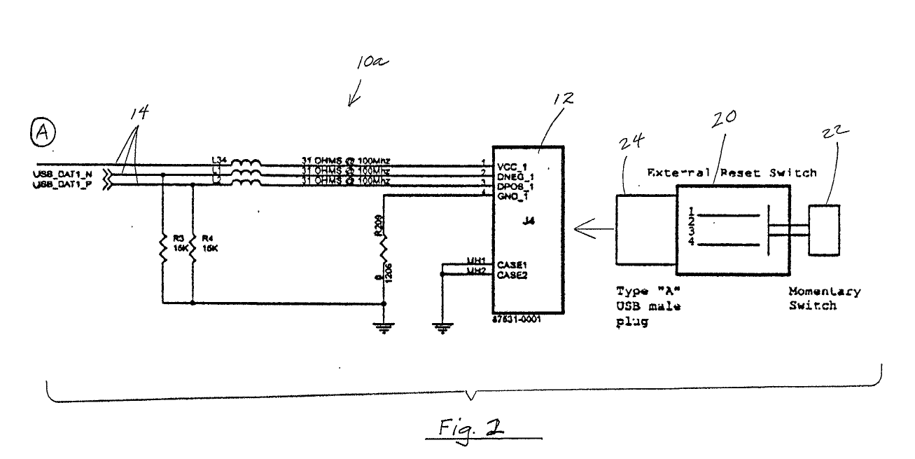

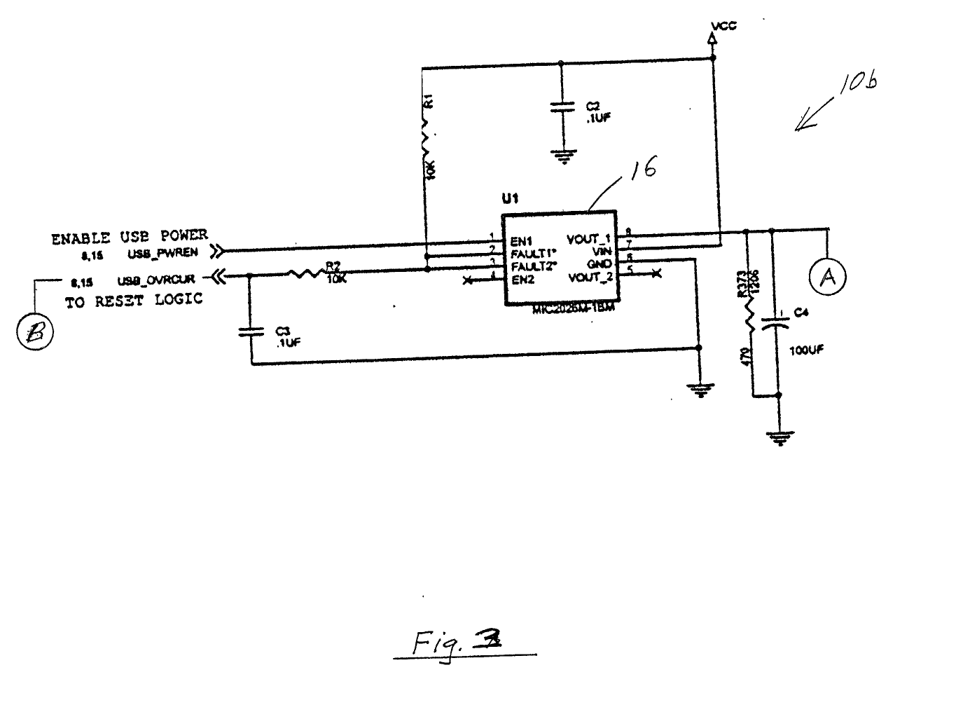

Referring now to FIGS. 2 and 3, a USB connective cable 14 is shown in two portions 14a and 14b that are connected to one another at terminal A, including components for protection of the connected computer against power surges. At an input end, cable 14 has a type A USB female connector 24 with terminals 1, 2, 3, and 4 connected thereto. Cable 14 connects from connector 24 to overcurrent protection unit 26 with intermediate resistors and capacitors inserted therein. A normally open manually operable switch 30 is adapted for engaging USB female connector 24 through integral type A male connector 32 located on one end thereof. A pushbutton 34 is connected in a manner, when depressed, to activate momentary switch 30.

Since the purpose of the present invention is to enable a remote user to restart a computer processor that has become frozen, a signal to the code processing section would be pointless. More specifically, if the processor is “hung”, or locked up, then sending a signal, through a USB port or any other port, will not cause the processor to reset, since the processor will not read the signal. Thus, auxiliary connections are provided from the USB cable to a circuit that is configured to authenticate and respond to a reset request signal when the processor is locked up.

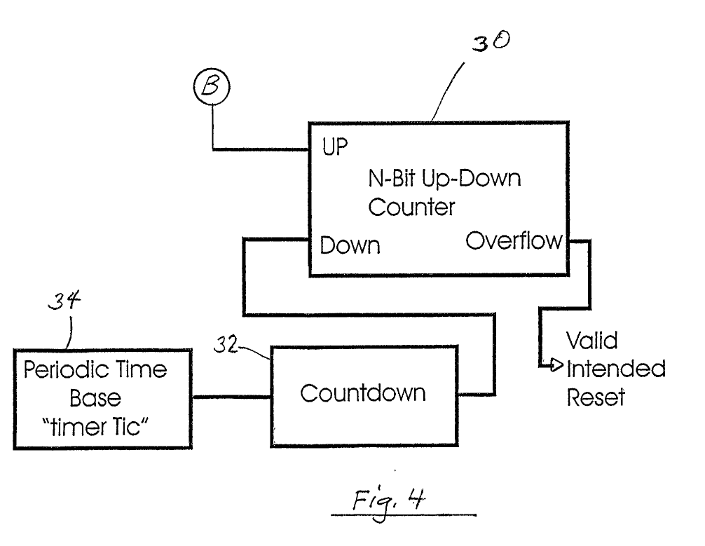

Momentary switch 30 is configured internally to close a selected pair of contacts, for example contacts 1 and 4. The signal of a momentary short circuit initiated by closure of switch 30 is transmitted to terminals 1 and 4 of USB female connector 24, and through cable 14 to a selected contact, for example terminal 8 of overcurrent protection unit 26. The short circuit signal is then transmitted to connection B of counter circuit 40 depicted in FIG. 4, at connection B.

Referring now to FIG. 4, an intentionally generated short circuit signal from manually operable switch 30 is transmitted from connection B to counter 40 that is located in the vicinity of SBC 12 as a separate circuit. Counter 40 is connected outside of the processor system so at not to be affected when SBC 12 is frozen. Counter 40 is configured with two counting sections, schematically represented as countdown section 42 and periodic time section 44. In operation, countdown section 42 receives and records short circuit signals up to a preset number, for example between two and five, and time section 44 maintains a clock for determination of time passage up to a preset amount, for example between two and four seconds.

Preferably, if countdown section 42 receives exactly three signals while timer 44 counts a time period of less than three seconds, counter 40 transmits a reset request signal to the selected computer processor power circuit. The triggering event of three short circuit signals within three seconds is offered as an example, and not a limitation of the invention disclosed. Other numbers, as long as it is greater than one signal received in other time periods, are possible. In this manner, counter 40 is able to distinguish between an actual, accidental, short circuit, typically being an isolated event, from an intended reset signal of multiple short circuits in a short time interval.

Since an accidental short circuit is a single signal, and the invention described herein is only operative on the receipt of multiple signals, particularly a preset number of signals in a selected time period, the invention effectively distinguishes the intentional signal generation. A single fault simulation signal may be used, but is less reliable.

As will be appreciated by those skilled in the trade, a short circuit is offered as an exemplary, but not exclusive, form of fault that may be simulated intentionally according to the present invention. Thus, the principles described herein pertain to a short circuit and other types of computer fault. According to the preferred embodiment, a repeated simulated fault for a selected number of occurrences in a selected time interval would provide to the fault distinguishing circuit a verification that the signal is genuine and intentional. The fault distinguishing circuit would then respond by generating and transmitting a reset request signal to the power supply to momentarily disconnect power and then reconnect power, causing the computer processor to reset.

While the present invention is described with respect to specific embodiments thereof, it is recognized that various modifications and variations thereof may be made without departing from the scope and spirit of the invention, which is more clearly understood by reference to the claims appended hereto.

What is claimed is:

1. A remote computer processor reset apparatus comprising a manually operable switch, a connective circuit in electrical communication at a first end thereof with the manually operable switch and a counter having a first section for counting events, a second section for counting time, and being capable of distinguishing between an unintentional short circuit and an intentional reset request, the counter being in electrical communication with a second end of the connective circuit and further connected at a second end thereof to the computer processor so as to transmit a responsive reset signal thereto.

2. The remote computer processor reset apparatus as described in claim 1, wherein the counter is adapted to transmit a signal to the computer processor in response to a successive plurality of short circuit signals received within a predetermined time period.

3. The remote computer processor reset apparatus as described in claim 2, wherein the counter is responsive to from two to five successive signals received within two to four seconds.

4. The remote computer processor reset apparatus as described in claim 3, wherein the logic circuit is responsive to three successive signals received within three seconds.

5. The remote computer processor reset apparatus as described in claim 1, wherein the manually operable switch is a momentary contact switch.

6. A method for resetting a remote computer processor comprising the steps of connecting to the computer processor a counter capable of distinguishing an accidental short circuit from an intentional reset request and transmitting a reset request signal to the computer processor in response to a determination that an intentional reset request has occurred.

7. The method for resetting a remotely located computer processor as claimed in claim 6, wherein the step of connecting to the computer a counter comprises the counter comparing the number of signals in a selected time period to a preset value.

8. The method for resetting a remotely located computer processor as claimed in claim 6, further comprising counting the number of signals received in a selected period of time, and if the number of signals received in the selected period of time equals a selected number, transmitting a reset request to the computer processor.

9. The method for resetting a remotely located computer processor as claimed in claim 8, wherein the number of signals is between three and five and the selected time period is between two and four seconds.

10. The method for resetting a remotely located computer processor as claimed in claim 9, wherein the number of signals is three and the selected time period is three seconds.

11. A remote computer processor reset apparatus having means for distinguishing between an unintentional short circuit and a signal intended for remotely resetting the processor when the processor is frozen, comprising:
a) means for receiving and counting plural discrete input signals;
b) means for determining time from a first of the plural discrete input signals to end at a selected time interval; and
c) the means for receiving and counting being programmed to transmit a reset request signal to the frozen remote processor if the number of input signals in the selected time internal equals a selected number.

12. Apparatus for resetting a remotely located computer processor when the computer processor is frozen, comprising:
(a) an auxiliary circuit for distinguishing an intentional signal from an unintentional fault and transmitting a reset request signal in response to a determination that a received signal is intentional:
(b) means for generating an intentional signal;
(c) means connecting the signal generating means to the auxiliary circuit; and
(d) means connecting the auxiliary circuit to a computer processor power supply for resetting the computer processor in response to a reset request.

13. The apparatus for resetting a remote computer processor as described in claim 12, wherein the means for generating an intentional signal comprises a momentary contact switch.

14. The apparatus for resetting a remote computer processor as described in claim 12, wherein the means connecting the signal generating means to the auxiliary circuit comprises a USB connective cable.

15. The apparatus for resetting a remote computer processor as described in claim 12, wherein the intentional signal comprises a selected number of fault simulations generated within a selected time interval.

16. The apparatus for resetting a remote computer processor as described in claim 15, wherein the selected number of fault simulations is three fault simulations.

17. The apparatus for resetting a remote computer processor as described in claim 16, wherein the selected time interval is three seconds.
